(19) United States
(12) Patent Application Publication
(10) Pub. No.: US 2012/0003512 A1
(43) Pub. Date: Jan. 5, 2012

(54) SECONDARY BATTERY AND PRODUCTION METHOD THEREOF

(76) Inventors: Ryuji Kohno, Ibaraki (JP); Yutaka Sato, Ibaraki (JP); Takuro Tsunaki, Ibaraki (JP); Fujio Hirano, Kanagawa (JP); Mitsuru Koseki, Saitama (JP)

(21) Appl. No.: 13/126,184

(22) PCT Filed: Oct. 22, 2009
(86) PCT No.: PCT/JP2009/068201

§ 371 Date: Jul. 8, 2011

(30) Foreign Application Priority Data
Oct. 27, 2008 (JP) 2008-275137

(51) Int. Cl. H01M 2/26; H01M 2/04; H01M 10/04; H01M 2/30; H01M 2/12

(52) U.S. Cl. 429/53; 429/179; 429/175; 29/623.1

(57) ABSTRACT

A secondary battery includes a battery can 1 and a battery lid that seals an opening of the battery can 1. In a space defined by the battery can 1 and the battery lid 3, a power generation element group 6 formed by winding a positive plate and a negative plate are disposed. The battery can is formed in a shallow, bottomed rectangular shape, in which a length of one side perpendicular to a bottom of the shallow bottomed rectangle is smaller than lengths of other two sides. In the opposite ends of the power generation element group 6, uncoated sections 6A and 6B where no active material mix is coated are exposed. The power generation element group 6 is disposed so that the uncoated sections 6A and 6B are positioned directly above the through holes 1B. The connection members electrically and mechanically connected to the uncoated sections 6A and 6B are included to provide electrical continuity with an outside of the battery through the through holes 1B.

### TECHNICAL FIELD

The present invention relates to a secondary battery and a production method thereof, in particular, a secondary battery which includes a rectangular battery can in which an opening is formed, a battery lid which seals the opening of the battery can, and a power generation element group which includes positive and negative plates and is disposed in a space defined by the battery can and the battery lid, and the production method thereof.

### BACKGROUND ART

At the request of the society for protection of the global environment, there is an urgent need for a practical, widespread use of a vehicle drive secondary battery for a hybrid vehicle, an electric vehicle, and the like, and development races are active. A known structure of a vehicle drive secondary battery includes positive electrode and negative electrode sheets (positive and negative plates), which are power generation elements, an insulating separator between the positive and negative plates, and electrolytic solution, which are housed in a metal or resin airtight container, and includes external terminals connected to the both electrodes of the power generation elements. Most of existing practically used secondary batteries have a cylindrical shape. However, in order to improve output and capacity, a vehicle drive secondary battery requires several tens to over hundred of secondary batteries to be brought together in a battery assembly and to be mounted to a vehicle. In order to improve the packing density, therefore, practical use of rectangular secondary batteries has been intensively discussed.

A conventional rectangular secondary battery typically includes sections formed at each end of a power generation element group, on which positive and negative electrode mixtures are not coated, and a connecting plate joined to each of the uncoated sections. The shape of the connecting plates is limited by the shape of the power generation element group and of the battery can, and thus the current path length is inevitably increased and the current path width is inevitably reduced. Since electric resistance is proportional to the current path length and inversely proportional to the current path width, a secondary battery has a problem that (1) reduction of the battery internal resistance is difficult.

In addition, since a battery can is produced by a deep drawing process, in which the production process is divided into many processes so that the battery can is formed gradually, die cost and manufacturing cost become high. In other words, a secondary battery 70 has other problems such as (2) the overall battery dimensions have to be large, (3) it becomes difficult to house a power generation element group 46 into a battery can 41, and (4) the cost of the battery can 41 is increased.

In order to solve those problems (1) to (4), a technique to seal a relatively shallow battery can having a large opening and a small length of a DH direction with a flat, plate-like battery lid is disclosed (refer to patent literature 1 for instance). However, the technique of patent literature 1 has the following problem since the positive and negative terminals are each disposed on the battery lid. Namely, as described above, a vehicle secondary battery system includes several tens to over hundred of secondary batteries connected in series or in parallel to constitute a battery assembly having a desired output and capacity. At this time, in general, each of the secondary batteries is arrayed in the DH direction with the interval between one secondary battery and its adjacent battery being limited to several millimeters in view of packing density. With the technique of patent literature 1, the positive and negative terminals disposed on the battery lid are hidden in a gap between the secondary battery and its adjacent secondary battery, and it is thus physically difficult to connect between the secondary batteries. In other words, the secondary battery of patent literature 1 has a problem of (5) difficulty in bringing the secondary batteries together into a battery assembly. In order to avoid this, it is necessary to extend the positive and negative terminals out from the outline of a WH direction or an HH direction of the battery can, respectively. However, if a laser beam or an electron beam is irradiate from above the battery lid when welding the battery can with the battery lid, the beam passes directly above the positive and negative terminals, thereby making it impossible to weld the battery can and the battery lid directly below the terminals. On the other hand, although a means for irradiating a beam from the bottom side of the battery can may be conceived, in general, in a secondary battery with the DH dimension of about 10 to 20 mm interferes with the beam source at the bottom surface of the can. Thus, with the technique of patent literature 1, the positive and negative terminals can not be extended out from the outline of the WH direction or the HH direction, thereby making it difficult to bring into a battery assembly.

In order to solve the problem (5) in addition to the problems (1) to (4) described above, a technique to extend positive and negative terminals out from a side surface of the battery can through the outline of the WH direction is disclosed (refer to patent literature 2, patent literature 3, and patent literature 4). With the techniques of patent literature 2 to patent literature 4, by extending the positive and negative terminals out from the outline of the battery can, a welding beam irradiated from above the battery lid can be prevented from interfering with the positive and negative terminals.

### CITATION LIST

### Patent Literature

PATENT LITERATURE 1 Japanese Patent No. 3997369
PATENT LITERATURE 2 Japanese Patent No. 3427216
PATENT LITERATURE 3 Japanese Patent No. 3482604
PATENT LITERATURE 4 Japanese Patent No, 3553719

### SUMMARY OF INVENTION

### Technical Problem

However, whilst for assembling a battery it is preferable that the moving directions of each member (each component) constituting a secondary battery and a jig supporting the assembly are in a same direction, ideally the vertical direction of the secondary battery, the techniques of patent literature 2 to patent literature 4 have the following problem. Namely, since electrical continuity is provided between the housed power generation element group and the outside on the side surface, i.e., the side which is perpendicular to the opening, of the battery can, it is essential to lead the positive and negative terminals from the outside to the WH direction and insert each of them into the side surface of the battery can, thereby resulting in troublesome assembly and increase in cost. In addition, since after inserting the positive and negative terminals, the power generation element group and the positive and negative terminals are connected with each other, it is difficult to support the connection sections in the battery can and apply load in the DH direction. Accordingly, there is a problem of (6) resulting in an increase in cost of battery assembling and thus battery manufacturing. In addition, airtight sealing of a battery can and a battery lid by a double seaming method is possible for and widely practiced in a battery can mainly made of flexible iron material (refer also to patent literature 2). However, it is difficult to achieve airtight sealing with aluminium material, which is demanded in terms of reduction in weight of a battery, because cracking or other failures may occur. For this reason, there is a problem of (7) difficulty in reducing the battery can and the battery lid in weight. As a result, it is at present difficult to solve the problems (1) to (4), in particular the problem of internal resistance in the problem (1) and the overall battery dimensions in the problem (2), without causing the problems (5) to (7) described above.

In view of the above matters, the present invention intends to provide a secondary battery with reduced internal resistance.

### Solution to Problem

In order to solve the above described problem, a secondary battery according to a first aspect of the present invention comprises: a battery can having a shallow, bottomed rectangular shape, in which a length of one side perpendicular to a bottom of the shallow bottomed rectangle is smaller than lengths of other two sides, and a through hole is formed in a vicinity of each of two opposite sides among four sides constituting an outer circumference of the bottom; a battery lid that seals an opening formed on a side opposite to the bottom of the battery can; a power generation element group, placed in a space defined by the battery can and the battery lid, that comprises positive plate and negative plate which are wound or laminated, with uncoated sections of active material mix being formed opposite with each other on the positive plate and the negative plate, and the uncoated sections of the positive plate and the negative plate being placed inside so as to face a surface in which the through holes of the battery can are formed; and a connection member that is electrically and mechanically connected to each of the uncoated sections of the positive plate and the negative plate so as to provide electrical continuity with an outside of the battery through the through holes of the battery can.

In the first aspect, the through hole may be formed on each side region of the bottom, and the connection member which is connected to the positive plate to provide electrical continuity with the outside of the battery through the through hole may extend opposite to the connection member which is connected to the negative plate to provide electrical continuity with the outside of the battery through the through hole. The battery can may include an offset surface located in a vicinity of each of the two opposite sides among the four sides constituting the outer circumference of the bottom, with the offset surface being displaced toward the battery lid from a plane of the bottom, and the through hole may be formed on the offset surface. The battery can may be provided with a plurality of the through holes formed on each of the offset surfaces, and the connection member may be electrically and mechanically connected to the uncoated sections of the positive plate and the negative plate through each of the through holes. The connection member may include a connection section electrically and mechanically connected to the uncoated sections of the positive plate and the negative plate and an extension section integrally formed with the connection section and extending outside the battery can, and the extension section may be bent along an outer bottom of the battery can and along one side perpendicular to the bottom, with one end of the extension section extending toward the battery lid. The battery can may include a safety valve which releases internal pressure when battery internal pressure rises on a side surface adjacent to any one side other than the two sides in the vicinity of which the through holes are formed. The battery lid has an outline which matches an outline of a member forming an opening of the battery can, and may be welded to the opening of the battery can. The connection member may be constituted with a connecting plate one side of which is joined to a surface toward the bottom of the battery can of each of the uncoated sections and an external terminal that includes a raised region with a flat protruding end on one side with an other side being led to outside, and the protruding end of the external terminal may be joined to an other side of the connecting plate through the through hole of the battery can. The connection member may be constituted with a flat, plate-like external terminal and a cup-like connection terminal fixed to the external terminal, and a cup outer bottom surface of the connection terminal may be joined to each of the uncoated sections through the through hole of the battery can. The battery can and the battery lid may be made of aluminium or aluminium alloy.

There may be further provided a resin plate disposed between the power generation element group and the battery lid and between the power generation element group and the battery can. In the resin plate disposed between the power generation element group and the battery can cut-out portions may be formed at positions corresponding to the through holes of the battery can. A cut-out portion may be formed on at least one side constituting an outer circumference of the resin plate disposed between the power generation element group and the battery lid.

In order to solve the above problem, according to a second aspect of the present invention, a production method for a secondary battery according to the first aspect comprises: a fixation step in which the connection member is fixed to each of the through holes of the battery can, with the insulating member placed therebetween; a connection step in which the power generation element group is placed in the battery can so as to electrically and mechanically connect the connection member with the uncoated sections of the positive plate and the negative plate; and a join step in which the battery can and the battery lid are joined. It is preferable that, in the connection step, the power generation element group is placed inside so that each of the uncoated sections of the positive plate and the negative plate faces a surface on which the through holes of the battery can are formed.

### Advantageous Effect of the Invention

According to the present invention, since uncoated sections of positive and negative plates constituting power generation element group are placed inside opposite each other on a surface on which a through hole of the battery can is formed and a connection member connected to each uncoated section is electrically communicated with the outside of the battery through the through hole, the following advantageous effects can be achieved, i.e., the current path from the power generation element group to the outside of the battery can be reduced in length, thereby reducing internal resistance, and the interior of the battery can be downsized, thereby reducing the battery in size.

### BRIEF DESCRIPTION OF THE DRAWINGS

FIG. 1 An illustration of the exterior of a secondary battery of an embodiment to which the present invention is applied, with FIG. 1(A) showing a perspective view seen from a battery lid direction and FIG. 1(B) showing a perspective view seen from a battery can bottom surface direction.

FIG. 2 An exploded perspective view showing the component configuration of the secondary battery of an embodiment.

FIG. 3 An illustration of the secondary battery of the embodiment, which is a perspective view of the Q-Q cross section of FIG. 1(A).

FIG. 4 An illustration of the exterior of a power generation element group constituting the secondary battery of the embodiment, with FIG. 4(A) showing a perspective view of positive and negative plates to be wound and FIG. 4(B) showing a perspective view of positive and negative plates to be laminated.

FIG. 5 A bottom surface view showing a secondary battery of another embodiment to which the present invention is applied.

FIG. 6 A partial cross-sectional view showing a connection section of a power generation element group of a secondary battery with an external terminal according to another embodiment.

FIG. 7 A bottom surface view showing a secondary battery of yet another embodiment to which the present invention is applied.

FIG. 8 An exploded perspective view showing a rectangular secondary battery of a comparison example.

### DESCRIPTION OF EMBODIMENTS

An embodiment of a lithium-ion secondary battery to which the present invention is applied will now be explained with reference to the drawings.

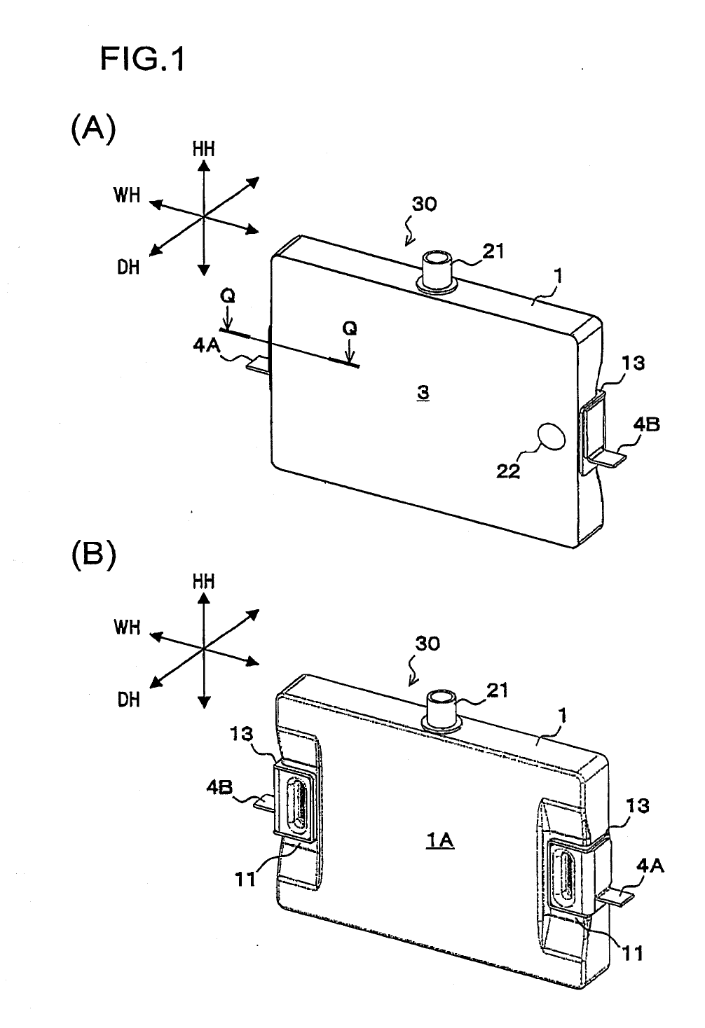

As shown in FIG. 1(A), a lithium-ion secondary battery 30 of the present embodiment includes a battery can 1 having an opening over the whole surface and a battery lid 3 sealing the opening of the battery can 1. In a space defined by the battery can 1 and the battery lid 3, a power generation element group formed by winding positive and negative plates is disposed and saturated with electrolytic solution.

The battery can 1 has a shape with the length of any of two perpendicular sides among four sides constituting the outer circumference of the opening being greater than the length of another side perpendicular to the above two sides. In other words, the battery can 1 has a shallow, bottomed rectangular shape with the length of a side perpendicular to the bottom being smaller than the lengths of the other two sides. The battery can 1 is made of aluminium in this example. Two side surfaces perpendicular to the bottom surface of the battery can 1 and facing each other (both left and right sides of FIG. 1(A)) is provided with a positive terminal 4A and a negative terminal 4B (part of a connection member), respectively. One of side surfaces of the battery can 1 on which the positive terminal 4A and the negative terminal 4B are not disposed is provided with a weakened section (safety valve) that automatically cleaves for releasing internal pressure in time of contingency of battery internal pressure rise, and a site in which the weakened section is formed is provided with a cylindrical protection member 21. The battery lid 3 has a flat plate shape whose outline matches the outline of the opening of the battery can 1. This battery lid 3 is formed so that the amount of unevenness in the thickness direction is smaller than the amount of unevenness of the battery can 1. The battery lid 3 is provided with an electrolyte filling inlet for filling electrolytic solution and the electrolyte filling inlet is sealed with an electrolyte filling plug 22. The battery lid 3 is made of aluminium in this example.

The battery can 1 is, as shown in FIG. 1(B), formed so that in the vicinity of two opposite sides among the four sides constituting the outer circumference of a bottom surface 1A, an offset surface 11 is formed in a substantial center of each of the two sides. The offset surfaces 11 are positioned closer to the battery lid 3 than the bottom surface 1A is. More specifically, the distance between a offset surface 11 and the battery lid 3 is less than that between the bottom surface 1A and the battery lid 3. In other words, recesses are formed on the bottom surface 1A in the vicinity of the two opposite sides. A through hole is formed on each of the offset surfaces 11 in the substantial center. The through holes are formed in the side end regions of the bottom of the battery can 1, and each hole has an oval shape along the vicinity side, i.e., the outer edge of the bottom surface 1A. One end of the positive terminal 4A and one end of the negative terminal 4B are each inserted into the through hole through an insulation seal 13. Each of the positive terminal 4A and the negative terminal 4B has a wide shape, and extends from the bottom surface 1A, in particular, the offset surface 11, to the side surface of the battery can 1 through the seal 13. In other words, the positive terminal 4A and the negative terminal 4B extend out from the offset surfaces 11 of the battery can 1, as starting points, to the side surfaces, are bent at the outer edge of the bottom surface 1A, and then extend toward the battery lid 3. The positive terminal 4A and the negative terminal 4B are bent again at a position of the side surfaces of the battery can 1 so that the other ends of the terminals extend out from the outline of the battery can 1.

In the interests of brevity of the following explanations, the three-dimensional three directions of the lithium-ion secondary battery 30 will now be defined as follows. More specifically, a direction between the positive terminal 4A and the negative terminal 4B of the battery can 1 is defined as the WH direction, a thickness direction between the bottom surface 1A and the battery lid 3 of the battery can 1 is defined as the DH direction, and a direction perpendicular to the WH direction and the DH direction is defined as the HH direction.

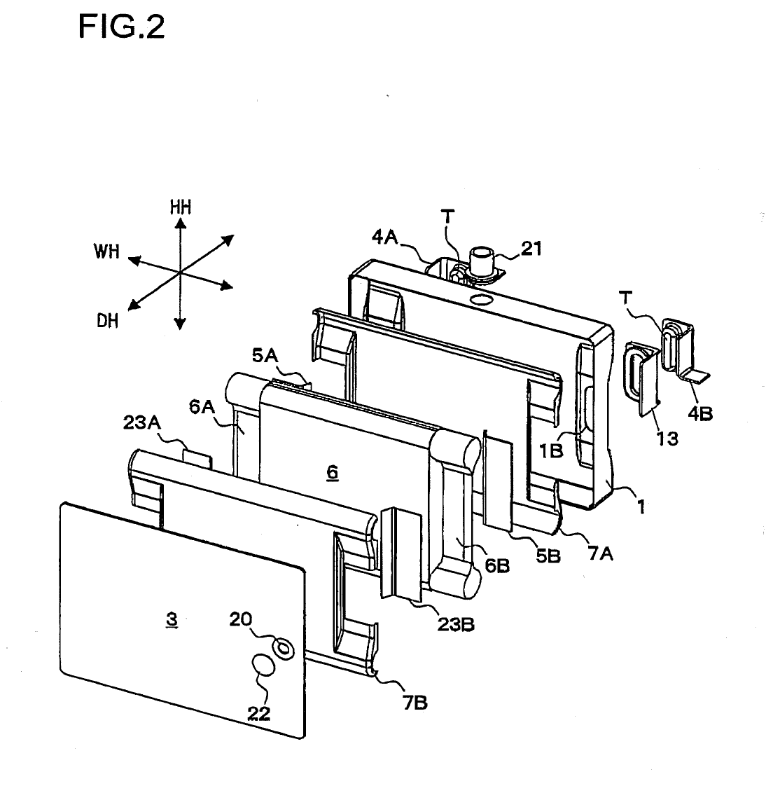

As shown in FIG. 2, a power generation element group 6 is placed in a space defined by the battery can 1 and the battery lid 3. In the power generation element group 6, the positive plate and the negative plate are wound into a flat shape with oval cross section. Uncoated sections 6A and 6B of the positive and negative plates on which no active material mix is applied are disposed at the both ends, i.e., both sides in the WH direction, of the power generation element group 6. In short, the uncoated sections 6A and 6B of the positive and negative plates are disposed opposite to each other. The substantial center of each of the uncoated sections 6A and 6B in the HH direction is pressed into a flat shape, and in the pressed substantial center, the both ends in the HH direction and the side toward the section coated with the active material mix of the positive and negative plates have a sloping shape.

On the battery can 1 side of the uncoated sections 6A and 6B, connecting plates 5A and 5B (parts of connection members) are provided so as to connect the uncoated sections 6A and 6B to the positive terminal 4A and the negative terminal 4B, respectively. The connecting plates 5A and 5B are prepared by bending flat, plate-like members until they have an L-shaped cross section and extend from the uncoated sections 6A and 6B along sloping surfaces toward the coated sections of the positive and negative plates. On the other hand, on the battery lid 3 side of the uncoated sections 6A and 6B, joint plates 23A and 23B are provided so as to maintain flatness of the uncoated sections 6A and 6B when joining with the connecting plates 5A and 5B, respectively. The joint plates 23A and 23B are prepared by bending flat, plate-like members until they have an L-shaped cross section and extend from the uncoated sections 6A and 6B along sloping surfaces toward the coated sections of the positive and negative plates. In other words, in the DH direction of the uncoated sections 6A and 6B, the connecting plates 5A and 5B are provided on the battery can 1 side, respectively, and the joint plates 23A and 23B are provided on the battery lid 3 side, respectively. The uncoated section 6A is sandwiched by the connecting plate 5A and the joint plate 23A and mechanically and electrically joined, for example, by ultrasonic welding. The uncoated section 6B is sandwiched by the connecting plate 5B and the joint plate 23B and joined in a similar manner as in the uncoated section 6A. In other words, one sides of the uncoated sections 6A and 6B are joined with one sides of the connecting plates 5A and 5B, respectively. In this example, the connecting plate 5A and the joint plate 23A are made of aluminium, and the connecting plate 5B and the joint plate 23B are made of copper.

The bottom surface 1A of the battery can 1 are provided with through holes 1B on the both side regions in the WH direction. The positive terminal 4A and the negative terminal 4B are inserted into the through holes 1B through the seal 13, respectively. The seal 13 is made of resin such as polyphenylene sulfide (PPS) or polybutylene terephthalate (PBT) and prepared by bending a rectangular, flat, plate-like member until it has an L-shaped cross section. The seal 13 is provided with a through hole with the same shape as the through hole 1B on one side thereof and the circumference of the through hole has a ring-like raised region which can be inserted into the through hole 1B. A groove into which the inner circumference side end of the through hole 1B can be fitted is formed in the outer circumference surface of that ring-like raised region. Namely, the inner circumference side end of the through hole 1B is fitted in the groove of the ring-like raised region, so that the seal 13 is fixed to the battery can 1.

An electrolyte filling inlet 20 for filling electrolytic solution is formed on the battery lid 3 in a substantial center of one side in the WH direction. This electrolyte filling inlet 20 is sealed with the electrolyte filling plug 22. A resin plate-like insulation case 7A (resin plate) is placed between the power generation element group 6 and the battery can 1, and a resin plate-like insulation case 7B (resin plate) is placed between the power generation element group 6 and the battery lid 3. In other words, the insulation cases 7A and 7B are placed on the both sides in the DH direction of the power generation element group 6. In the insulation case 7A, cut-out portions are formed at positions corresponding to the through holes 1B of the battery can 1 in a substantial center of two opposite sides (at both sides in the WH direction). Each cut-out portion has a substantially same shape as that of the pressed portions of the uncoated sections 6A and 6B of the positive and negative plates. The insulation case 7B has the same shape as that of the insulation case 7A, and a cut-out portion is formed in a substantial center of each side of the WH direction. One of the cut-out portions formed in the insulation case 7B corresponds to a position of the electrolyte filling inlet 20. In the insulation cases 7A and 7B, each end of the both sides in the HH direction is curved towards the power generation element group 6 side so as to fit the shape of the power generation element group 6. Due to this, the curved edge of each side in the HH direction of the insulation case 7A abuts against the curved edge of each side in the HH direction of the insulation case 7B, and thus the insulation cases 7A and 7B press each other in the DH direction. The edges of the cut-out portions formed on the both sides in the WH direction of the insulation cases 7A and 7B each have a sloping shape so as to fit the shape of the uncoated sections 6A and 6B of the power generation element group 6. This allows the power generation element group 6 to be disposed in a space defined by the battery can 1 and the battery lid 3 in a state where the power generation element group 6 is sandwiched by the insulation cases 7A and 7B. The insulation cases 7A and 7B are provided to ensure insulation between the power generation element group 6, and the battery can 1 and the battery lid 3, and to relieve external stress if external force is applied to the power generation element group 6. The insulation cases 7A and 7B may be made of resin such as polyethylene terephthalate (PET) or polypropylene (PP).

The positive terminal 4A and the negative terminal 4B are made of the same material as current collector foil constituting the positive plate and the negative plate, respectively, and prepared by bending wide rectangular members until they have a L-shaped cross section. In this example, the positive terminal 4A is made of aluminium and the negative terminal 4B is made of copper. The positive terminal 4A and the negative terminal 4B each have a protrusion T with the same shape as that of the through holes 1B on one side. The protrusion T has a flat protruding end. In each of the positive terminal 4A and the negative terminal 4B, the protrusion T is inserted into the through hole 1B through the seal 13. The protruding ends of the protrusions T are joined to the other sides of the connecting plates 5A and 5B by for example, laser welding so that they are mechanically and electrically connected.

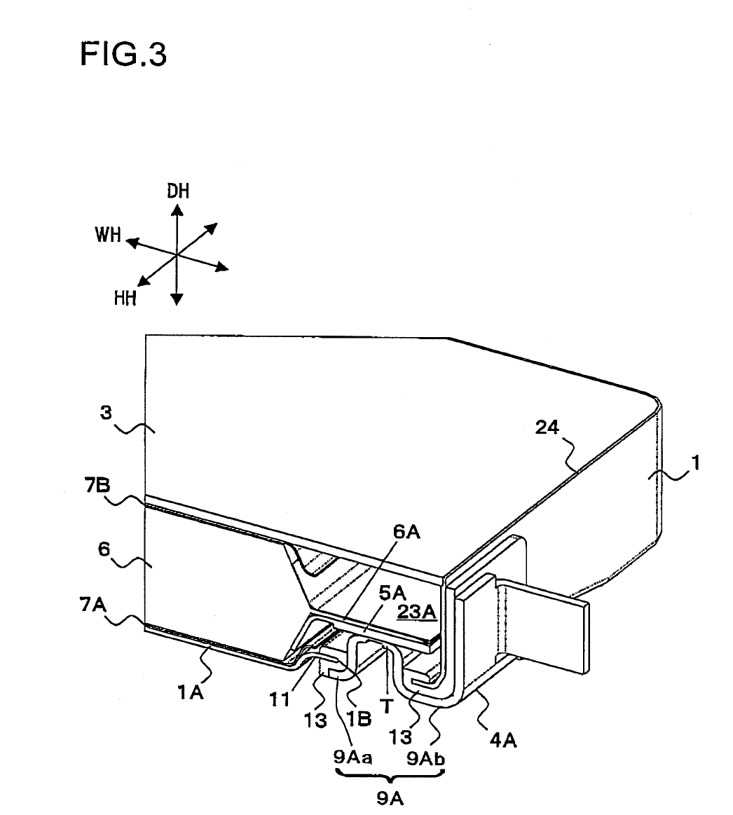

Next, a connection configuration of the power generation element group 6 with the positive terminal 4A and the negative terminal 4B will be explained, and, since the positive electrode side and the negative electrode side are formed in a similar manner, only the positive electrode side will be explained. As shown in FIG. 3, the joint plate 23A is joined to the battery lid 3 side of the uncoated section 6A of the positive plate, and (one surface side of) the connecting plate 5A is joined to the bottom surface 1A side (one surface side) of the uncoated section. The insulation cases 7A and 7B are placed between the power generation element group 6 and the battery can 1 and between the power generation element group and the battery lid 3, respectively. At the end of one side in the WH direction of the bottom surface 1A, the offset surface 11 is formed along the outer edge of the bottom surface 1A. In a substantial center of the offset surface 11, the through hole 1B is formed. The positive terminal 4A is inserted into the through hole 1B through the seal 13. The protruding end of the protrusion T of the positive terminal 4A is joined to (the other surface side of) the connecting plate 5A. In other words, in this example, the positive terminal 4A and the connecting plate 5A are electrically and mechanically connected to the uncoated section 6A and constitute a connection member 9A (corresponds to a connection member 9B on the negative electrode side) for providing electrical continuity with the outside of the battery through the through hole 1B. This connection member 9A includes a connection section 9Aa, which is electrically and mechanically connected to the uncoated section 6A, and an extension section 9Ab, which is formed integrally with the connection section 9Aa and extends out to the outside of the battery can 1. The connection section 9Aa is constituted with the connecting plate 5A and a portion of one side including the protrusion T of the positive terminal 4A, and the extension section 9Ab is constituted with a portion of the other side of the positive terminal 4A. The extension section 9Ab is bent at the outer edge of the bottom surface 1A so as to extend along the bottom surface 1A and the side surface adjacent to the bottom surface 1A of the battery can 1, and its one end extends out to the battery lid 3 side. A portion of the extension section 9Ab positioning on the side surface of the battery can 1 is bent in a substantial center of the HH direction, the bent portion extends out the outline of the battery can 1, i.e., to the outside in the WH direction. Since the negative electrode side is configured similarly to the positive electrode side, the positive terminal 4A and the negative terminal 4B (the connection member 9A and the connection member 9B) extend in opposite directions to each other.

An opening end of the battery can 1 is provided with a mating section 24, which is thin walled by a depth corresponding to the thickness of the battery lid 3. In other words, the opening of the battery can 1 is provided with a step at a depth corresponding to the thickness of the battery lid 3. The battery lid 3 is fitted to the mating section 24 of the battery can 1. The whole circumference of the battery lid 3 is welded with the mating section 24.

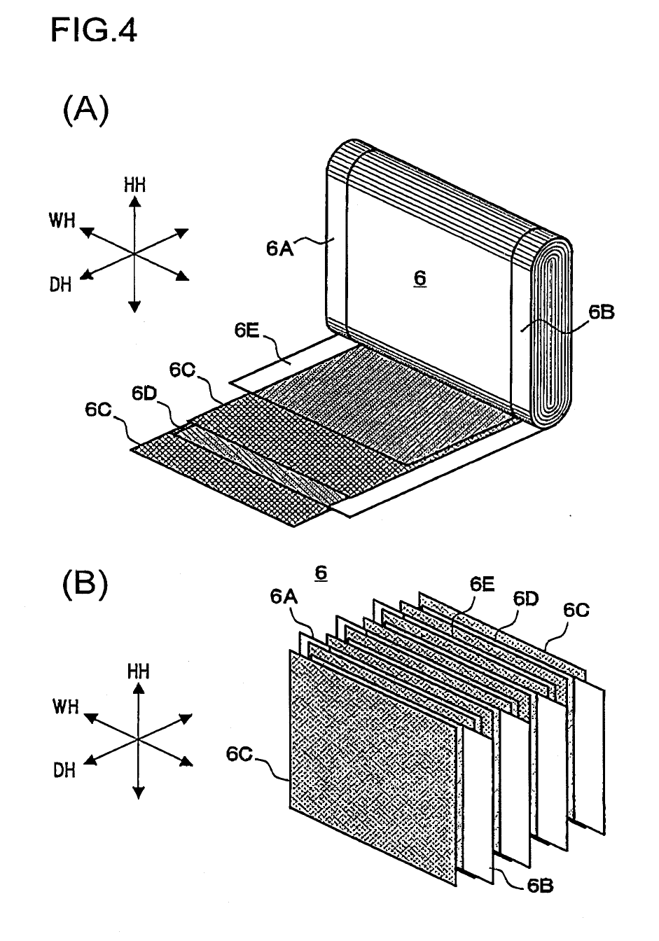

The power generation element group 6 is formed by winding and arranging the positive plate and the negative plate through a separator. As shown in FIG. 4(A), in the power generation element group 6 of winding type, an elongated rectangular positive plate 6E and an elongated rectangular negative plate 6D are wound through two elongated rectangular separators 6C. At this time, they are wound to have an oval cross section so that the uncoated section 6A of the positive plate 6E and the uncoated section 6B of the negative plate 6D are located at the both ends of the power generation element group 6, respectively. In the obtained power generation element group 6, the uncoated sections 6A and 6B are placed on the opposite sides with each other in the WH direction.

The positive plate 6E, which constitutes the power generation element group 6, includes aluminium foil as a positive electrode current collector foil. On the both sides of the aluminium foil, positive electrode active material mix including lithium-containing transition metal composite oxide such as lithium manganite is coated substantially equally and substantially evenly as a positive electrode active material. Other than the positive electrode active material, conductive material such as carbon material and a binder (binding agent) such as polyvinylidene fluoride (hereinafter abbreviated to PVDF) are mixed into the positive electrode active material mix. When the positive electrode active material mix is coated onto the aluminium foil, viscosity is controlled by a dispersion solvent such as N-methylpyrrolidone (hereinafter abbreviated to NMP). At this time, the uncoated section 6A on which the positive electrode active material mix is not coated is formed at one side edge of the aluminium foil along its longitudinal direction. In other words, the aluminium foil is exposed in the uncoated section 6A. In the positive plate 6E, density is controlled by roll pressing after drying.

On the other hand, the negative plate 6D includes copper foil as a negative electrode current collector foil. On the both sides of the copper foil, negative electrode active material mix including carbonaceous material such as graphite, which can reversibly absorb and release lithium ion, is coated substantially equally and substantially evenly as a negative electrode active material. Other than the negative electrode active material, conductive material such as acetylene black and a binder such as PVDF are mixed into the negative electrode active material mix. When the negative electrode active material mix is coated onto the copper foil, viscosity is controlled by a dispersion solvent such as NMP. At this time, the uncoated section 6B on which the negative electrode active material mix is not coated is formed at one side edge of the copper foil along its longitudinal direction. In other words, the copper foil is exposed in the uncoated section 6B. In the negative plate 6D, density is controlled by roll pressing after drying. It is to be noted that the length of the negative plate 6D is set to be greater than the length of the positive plate 6E so that when the positive plate 6E and the negative plate 6D are wound, the positive plate 6E does not protrude from the negative plate 6D in the winding direction at the innermost circumference and the outermost circumference of the winding. In addition, the width of the coated section of the negative electrode active material mix (i.e., the length in the WH direction) is set to be greater than the width of the coated section of positive electrode active material mix so that the coated section of the positive electrode active material mix does not protrude from the coated section of the negative electrode active material mix in the longitudinal direction of the power generation element group 6 (i.e., in the WH direction).

(Manufacture)

The lithium-ion secondary battery 30 is to be manufactured as follows. That is, the lithium-ion secondary battery 30 is manufactured in the following four steps, i.e., a preparatory step in which after winding positive and negative plates, the connecting plates 5A and 5B and the joint plates 23A and 23B are joined to the uncoated sections 6A and 6B, respectively, so as to prepare the power generation element group 6, a fixation step in which the positive terminal 4A and the negative terminal 4B are fixed to the through holes 1B of the battery can 1 through the seals 13, a connection step in which the power generation element group 6 is placed in the battery can 1 and the positive terminal 4A and the negative terminal 4B are electrically and mechanically connected with the connecting plates 5A and 5B, respectively, and a join step in which the battery can 1 and the battery lid 3 are joined. Explanations will now be made in the order of the steps.

(Preparatory Step)

In the preparatory step, the positive plate 6E and the negative plate 6D having been manufactured in advance are wound through the separator 6C. At this time, the separator 6C, the negative plate 6D, the separator 6C, and the positive plate 6E are laminated in this order and wounded from one side to form an oval cross section so that the uncoated section 6A of the positive plate 6E and the uncoated section 6B of the negative plate 6D are placed opposite with each other. The separator 6C is wound in two to three turns at a winding start and a winding end. The substantial centers of the HH direction of the uncoated sections 6A and 6B with spiral cross sections which are arranged on the opposite sides are pressed into flat shape (refer to FIG. 2 and FIG. 4). The connecting plates 5A and 5B are provided on one side of the uncoated sections 6A and 6B, respectively, and the joint plates 23A and 23B are provided on the other side of the uncoated sections. The power generation element group 6 is produced by performing ultrasonic processing on each of the uncoated section 6A side and the uncoated section 6B side, integrally joining the connecting plate 5A, the uncoated section 6A, and the joint plate 23A, and integrally joining the connecting plate 5B, the uncoated section 6B, and the joint plate 23B.

(Fixation Step)

In the fixation step, the positive terminal 4A and the negative terminal 4B are fixed to the through holes 1B of the battery can 1, respectively, through the seals 13. The protrusion T of each of the positive terminal 4A and the negative terminal 4B is inserted into the through hole of the seal 13, and the ring-like raised region of the seal 13 is fixed to the through hole 13, so that the positive terminal 4A and the negative terminal 4B are insert into the through holes 1B. In this example, the seal 13 is formed by transfer-molding resin material such as PPS or PBT into a gap between the battery can 1 and the positive terminal 4A and the negative terminal 4B while maintaining fixed distances between the battery can and the positive terminal and the negative terminal. The transfer molding allows relative positions of the battery can 1 and the positive terminal 4A and the negative terminal 4B to be fixed, insulation between them to be ensured, and an air seal is established.

(Connection Step)

In the connection step, the power generation element group 6 having been prepared in the preparatory step is placed in the battery can 1 through the insulation case 7A. At this time, it is placed so that the uncoated sections 6A and 6B are located directly above the through holes 1B formed on the both sides in the WH direction. In addition, it is placed so that the connecting plates 5A and 5B joined to the uncoated sections 6A and 6B, respectively, are opposite to the internal bottom surface of the battery can 1. The connecting plates 5A and 5B and the positive terminal 4A and the negative terminal 4B are electrically and mechanically connected, respectively, by laser beam welding. At this time, a laser beam is irradiated from the bottom surface 1A side of the battery can 1, i.e., the recessed regions of the positive terminal 4A and the negative terminal 4B towards the connecting plates 5A and 5B. It is to be noted that since the cut-out portions are formed in the insulation case 7A on the both sides in the WH direction, no trouble is caused when connecting the connecting plates 5A and 5B with the positive terminal 4A and the negative terminal 4B.

(Join Step)

In the join step, the insulation case 7B is placed on the power generation element group 6 in which the connecting plates 5A and 5B and the positive terminal 4A and the negative terminal 4B have been connected in the connection step. The outer circumference end of the battery lid 3 is fitted to the mating section 24 formed in the opening of the battery can 1. A laser beam is irradiated from above the battery lid 3 towards the fitting section of the battery lid 3 with the mating section 24, and the battery can 1 and the battery lid 3 are welded. After the electrolytic solution is filled through the electrolyte filling inlet 20, the electrolyte filling inlet is sealed with the electrolyte filling plug 22, and thus manufacture of the lithium-ion secondary battery 30 is completed. As electrolytic solution, in this example, a nonaqueous electrolytic solution in which lithium salt such as lithium hexafluorophosphate (LiPF6) is dissolved in a carbonate ester organic solvent such as ethylene carbonate. It is to be noted that since one of the cut-out portions formed on the both sides in the WH direction of the insulation case 7B is formed at a position corresponding to the electrolyte filling inlet 20, the insulation case 7B will not become an obstacle in filling.

(Operations and the Like)

Next, operations and the like of the lithium-ion secondary battery 30 of the present embodiment will be explained.

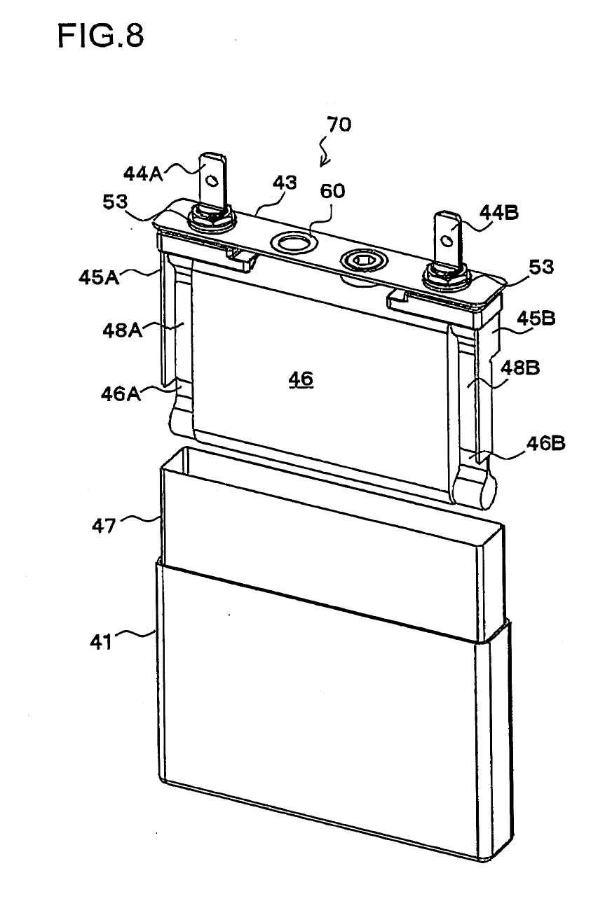

A prismatic secondary battery is normally configured as follows. Namely, as shown in FIG. 8 as a comparison example, the secondary battery 70 includes the battery can 41 in which the opening is formed by the deep drawing process so that the depth dimension is greater than the dimension of two perpendicular sides. The power generation element group 46 is housed in the battery can 41 through an insulation case 47. In the power generation element group 46, uncoated sections 46A and 46B of active material mix of positive and negative plates are formed on both ends. Connecting plates 45A and 45B are joined to the uncoated sections 46A and 46B through joints 48A and 48B, respectively. An opening of the battery can 41 is sealed with a battery lid 43. A positive terminal 44A and a negative terminal 44B are fixed to the battery lid 43 through a seal 53. An electrolytic solution is inlet into the battery can 41 from an electrolyte filling inlet 60 which is sealed in an airtight manner.

In such secondary battery 70, the connecting plates 45A and 45B extend out along the outline of the power generation element group 46 from the joints 48A and 48B to the positive terminal 44A and the negative terminal 44B. In addition, the width of each of the connecting plates 45A and 45B is equal to or less than the internal dimension of the thickness direction of the battery can 41. In other words, the shape of the connecting plates 45A and 45B is limited by the shape of the power generation element group 46 or the battery can 41, and thus the current path length is increased and the current path width is reduced. Because of this, electric resistance of the connecting plates 45A and 45B, and therefore battery internal resistance is increased, thereby resulting in a negative effect on battery performance such as charge and discharge characteristics. In other words, (1) there is a problem that reduction of the battery internal resistance becomes difficult. In addition, since the battery can 41 is formed in a shape to contain the power generation element group 46 and the connecting plates 45A and 45B as a whole, the overall dimensions of the battery can 41 is increased. In addition, since the power generation element group 46 is inserted deep into the narrow battery can 41, workability is reduced. In particular, if the surface of the power generation element group 46 is scratched by the opening of the battery can 41, such failures as damage of the power generation element group 46 and intrusion of material powder into the battery can 41 may be caused. Since it is essential to adopt the deep drawing process in producing this battery can 41, the cost is increased. In other words, a secondary battery 70 has other problems that (2) the overall battery dimensions have to be large, (3) it becomes difficult to house the power generation element group 46 into the battery can 41, and (4) the cost of the battery can 41 is increased.

While in order to solve the problems (1) to (4), there is a technique to use a shallow battery can having a large opening and a small length of the DH direction, there is a following problem in setting up the positive and negative terminals on the battery lid. Namely, a vehicle secondary battery system includes a plurality of secondary batteries arrayed in the DH direction to constitute a battery assembly in which those secondary batteries are connected in series or in parallel. As a result, the positive and negative terminals are hidden, and thus it is physically difficult to connect between the secondary batteries. In other words, there is a problem of (5) difficulty in bringing the secondary batteries together into a battery assembly. In order to avoid this, it is necessary to extend the positive and negative terminals out from the WH direction or the HH direction of the battery can, respectively. However, if a laser beam or an electron beam is irradiate from the upper side of the battery lid, the beam passes directly above the positive and negative terminals, thereby making it impossible to weld the battery can with the battery lid directly therebelow. In addition, for assembling a battery it is preferable that the moving directions of each member of a secondary battery and a jig supporting the assembly are in a same direction, ideally the vertical direction of the secondary battery. However, if the positive and negative terminals extend out from the side surface of the battery can to the outside in the WH direction, electrical continuity is provided between the power generation element group and the outside of the battery on the side surface of the battery can, and therefore it is essential to insert the positive and negative terminals from the outside of the WH direction into the side surface of the battery can, thereby resulting in troublesome assembly. In addition, it becomes difficult to support the connection section in the battery can when connecting the power generation element group with the positive and negative terminals. As a result, there is a problem of (6) resulting in an increase in battery manufacturing. In addition, whilst it is easy to airtight seal the battery can and the battery lid mainly made of iron material by the double seaming method or the like, it is difficult to achieve airtight sealing with aluminium, material, which is demanded in terms of reduction in weight of a battery, because cracking or other defects may occur. For this reason, there is a problem of (7) difficulty in reducing the battery can and the battery lid in weight. The secondary battery according to the present embodiment is provided to solve those problems (1) to (7).

In the lithium-ion secondary battery 30 of the present embodiment, the through holes 1B are formed on the offset surfaces 11 formed at the both ends in the WH direction of the bottom surface 1A of the battery can 1. The positive terminal 4A and the negative terminal 4B are fixed to this through holes 1B. The uncoated sections 6A and 6B of the positive and negative plates constituting the power generation element group 6 are located directly above or inside the through holes 1B of the battery can 1. The connecting plate 5A connected to the uncoated section 6A and the positive terminal 4A are joined and the connecting plate 5B connected to the uncoated section 6B and the negative terminal 4B are joined. This reduces the current path length from the power generation element group 6 to the positive terminal 4A and the negative terminal 4B, and therefore electric resistance can be reduced. In addition, the connecting plates 5A and 5B can be increased in width by the width of the uncoated sections 6A and 6B of the positive and negative plates (the length of the HH direction). This increases the width of the current path, and therefore electric resistance can be reduced. In other words, the length and the width of the current path from the power generation element group 6 to the outside of the battery can be set regardless of the size of the power generation element group 6 or the shape of the battery can 1. The current path length can be reduced to the length from the uncoated sections 6A and 6B to the nearest portion of the side surface of the battery can 1, and the width can be increased as appropriately within the width of the uncoated sections 6A and 6B. As a result, the lithium-ion secondary battery 30 can be reduced in internal resistance and improved in battery performance such as charge and discharge characteristics.

In addition, in the present embodiment, the uncoated sections 6A and 6B of positive and negative plates constituting the power generation element group 6 are each located inside and directly above the through holes 1B of the battery can 1. In the battery can 1, as a result, unlike the conventional secondary battery 70, the connecting plates 45A and 45B do not extend out in the WH direction and the HH direction along the outline of the power generation element group 46 (refer to FIG. 8). Thus, in the battery can 1, necessary dimensions in the WH direction and the HH direction can be minimized, and, as a result, the battery can be reduced in size.

In addition, in the present embodiment, the battery can 1 has a shallow, bottomed rectangular or prismatic shape which the length of each of two perpendicular sides among the four sides constituting the outer circumference of the opening is greater than the length of the side perpendicular to the above two sides. As a result, the opening of the battery can 1, the dimensions in the WH direction and the HH direction are increased and that in the DH direction is reduced, and thus the power generation element group 6 can easily be housed in a space defined by the battery can 1 and the battery lid 3. This can prevent the surface of the power generation element group 6 and the like from being damaged at the edge of the opening of the battery can 1. In addition, the shallowness of the battery can 1 can reduce the number of processes in drawing and forging when manufacturing the battery can. As a result, manufacturing of the battery can 1 can be made easy, the power generation element group 6 can be housed in the battery can 1 without trouble, and failure due to damage can be prevented from occurring. Thus, battery manufacturing can be improved in efficiency and reduced in cost.

In addition, in the present embodiment, the ends of the positive terminal 4A and the negative terminal 4B extend out from the outline in the WH direction of the battery can 1. The battery lid 3 has a substantially flat shape, and the through holes 1B through which the positive terminal 4A and the negative terminal 4B are fixed are formed on the offset surfaces 11 of the battery can 1. Thus, the lithium-ion secondary battery 30 is substantially flat on the both sides in the DH direction. As a result, the plurality of lithium-ion secondary batteries 30 can be arrayed in the DH direction so as to easily produce a battery assembly in which the lithium-ion secondary batteries are connected in series or parallel. In addition, unlike the conventional secondary battery 70 having the positive and negative terminals each disposed on the battery lid, a battery assembly can be assembled without a process of moving the positive terminal 4A and the negative terminal 4B. As a result, assembling a battery assembly can be reduced in cost, and bringing secondary batteries into a battery assembly can increase capacity and output, and therefore the battery assembly of the plurality of lithium-ion secondary batteries 30 is suitable for a use as a vehicle secondary battery system.

In addition, while an existing battery can and battery lid mainly made of iron are air-tightly sealed with ease by the double seaming method or the like, due to crack or the like it is difficult to air-tightly seal a battery can and a battery lid mainly made of aluminium by the double seaming method. In the present embodiment, the battery can 1 and the battery lid 3 can be welded by laser beam or the like. As a result, the battery can 1 and the battery lid 3 can be mainly formed of aluminium. Since this allows the battery can 1 and the battery lid 3 to be reduced in weight, the whole battery can be reduced in weight.

In addition, in the present embodiment, the offset surfaces 11 are formed on the battery can 1. This prevents the positive terminal 4A and the negative terminal 4B from protruding in the battery thickness direction (the DH direction) and from affecting the battery thickness dimension. As a result, the lithium-ion secondary battery 30 can be made thin. In addition, forming the through holes 1B on the offset surfaces 11 results in reduction in the length between the positive terminal 4A and the negative terminal 4B and the uncoated sections 6A and 6B of the positive and negative plates. As a result, the current path length can be further reduced, and internal resistance can be further reduced.

In addition, in the present embodiment, the insulation case 7A is placed between the power generation element group 6 and the battery can 1, and the insulation case 7B is placed between the power generation element group 6 and the battery lid 3. In other words, the power generation element group 6 is placed in a space defined by the battery can 1 and the battery lid 3 in a state of being sandwiched by the insulation cases 7A and 7B. This ensures insulation between the power generation element group 6 and the battery can 1 and the battery lid 3. In addition, the edge of each side in the HH direction of the insulation case 7A abuts against the edge of each side in the HH direction of the insulation case 7B. This causes the insulation cases 7A and 7B to press each other in the DH direction, and external stress to the power generation element group 6 can be relieved if external force is applied. As a result, the insulation cases 7A and 7B are provided so as to ensure insulation and protect the power generation element group 6 even if external force is applied.

It is to be noted that while in the present embodiment, an example is shown in which the connection member 9A, which is electrically and mechanically connected to the uncoated section 6A of the positive plate and provides electrical continuity with the outside of the battery though the through hole 1B, is constituted with the positive terminal 4A, which includes the protrusion T having a flat protruding end, and the flat, plate-like connecting plate 5A (the same is true for the negative electrode side.), the present invention is not to be limited thereto. For instance, it may be arranged that the connection member is constituted with a flat, plate-like positive terminal and a cup-like connection terminal fixed to this positive terminal and the cup outer bottom surface of the connection terminal is joined to an uncoated section of the positive plate through a through hole of the battery can. An example of such structure will be now explained.

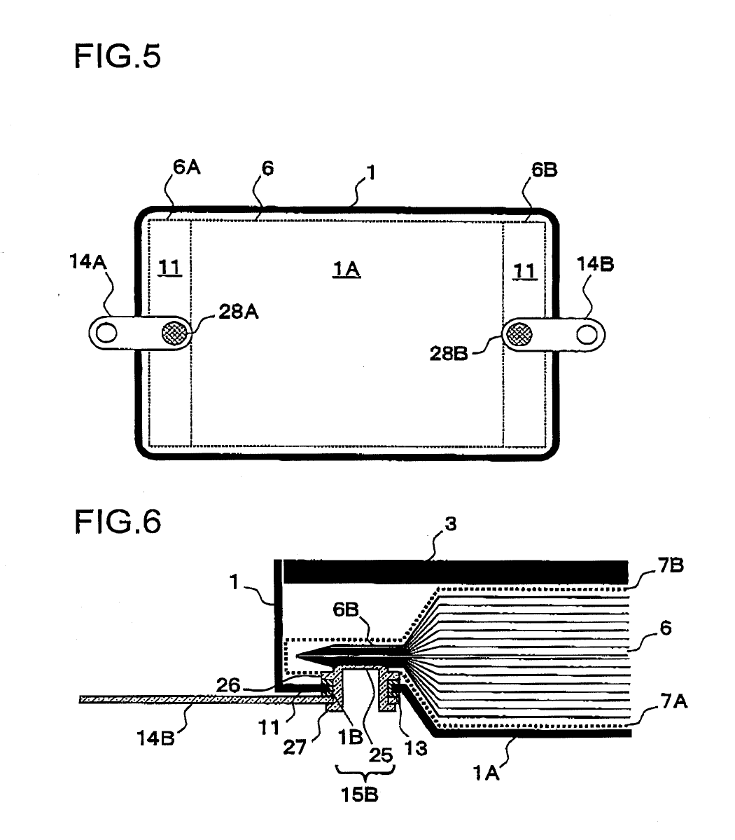

As shown in FIG. 5, a positive terminal 14A and a negative terminal 14B each have a substantially oval, flat, plate-like shape, and round through holes formed on the both sides in the longitudinal direction. In the positive terminal 14A and the negative terminal 14B, the through holes of one side are connected to connection sections 28A and 28B, respectively, which are each provided in a substantial center at the both ends of the bottom surface 1A of the battery can 1 (both left and right sides of FIG. 5). The positive terminal 14A and the negative terminal 14B extend out from the outline of the battery can 1 on the other side. As shown in FIG. 6, a metal connection terminal 15B has a cup-like (cylindrical) shape having a recess 25. The cup outer bottom surface of the connection terminal 15B has a substantially flat shape. The connection terminal 15B includes a flange 26 on the outer circumference of the cup outer bottom side. In the negative terminal 14B, the opening-side end of the connection terminal 15B is inserted into the through hole on one side. The connection terminal 15B is inserted into the through hole 1B formed on the offset surface 11 of the battery can 1 through the seal 13. The opening end of the connection terminal 15B is swaged and fixed by a crimp 27. In other words, in the connection terminal 15B, the offset surface 11, the negative terminal 14B, and the seal 13 are compressed by the flange 26 and the crimp 27 so as to fix their relative positions with one another. This seal 13 ensures insulation between the battery can 1 and the negative terminal 14B and airtight sealing in the battery can 1. The cup outer bottom surface of the connection terminal 15B is joined by, for example, ultrasonic welding with the uncoated section 6B of the negative plate constituting the power generation element group 6 placed inside and directly above the through hole 1B of the battery can 1.

According to such structure, in addition to the advantageous effects similar to those of the present embodiment described above, the following advantageous effects can be achieved. Namely, while in the present embodiment described above, the connecting plate 5B and the negative terminal 4B are welded by laser beam, the connection terminal 15B and the negative terminal 14B are swaged and fixed by the crimp, thereby making welding unnecessary. As a result, process can be simplified. However, it is needless to mention that a connection section between the connection terminal 15B and the negative terminal 14B may be welded if there is a concern with electrically conduction properties between them. In addition, while in FIG. 5 and FIG. 6 an example in which the negative terminal 14B extends straight out to the outside of the battery is shown, it is possible, if bringing a plurality of batteries into a battery assembly, to form the negative terminal 14B in the same manner as the positive terminal 4A and the negative terminal 4B of the present embodiment described above.

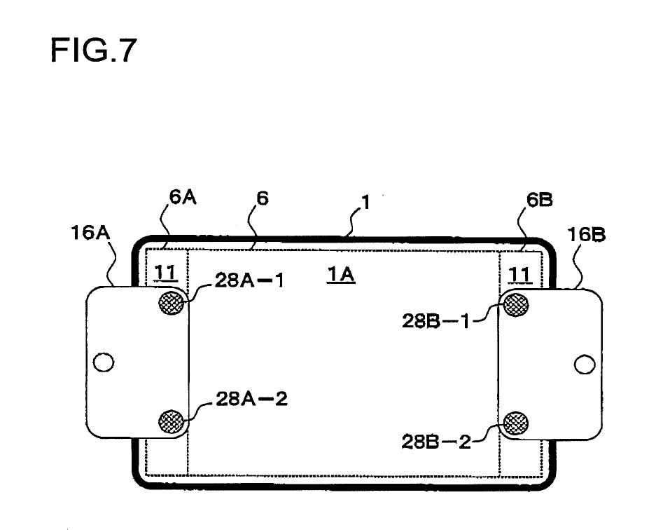

In addition, while in the present embodiment, an example in which the one through hole 1B of the battery can 1 is formed on each of the positive and negative electrode sides, the present invention is not to be limited thereto. A plurality of the through holes 1B may be formed on each of the positive and negative electrode sides. This can be achieved in the following manner. Namely, as shown in FIG. 7, the positive terminal 16A and the negative terminal 16B each have a rectangular, flat, plate-like shape, and one through hole formed on a side of two opposite sides and another two through holes formed on the other side. In the positive terminal 16A and the negative terminal 16B, the two through holes formed on the said other sides are connected to a pair of connection sections 28A-1 and 28A-2 and a pair of connection sections 28B-1 and 28B-2, respectively, at the both ends (both left and right sides of FIG. 7) of the bottom surface 1A of the battery can 1. The positive terminal 16A and the negative terminal 16B are connected to the uncoated sections 6A and 6B of the positive and negative plates, respectively, through the cup-like connection terminal 15B described above. According to such structure, the following advantageous effects can be achieved. Namely, since the uncoated sections 6A and 6B of the positive and negative plates and the positive terminal 16A and the negative terminal 16B are connected respectively at two points, the current path area can be increased, and, since current density is equalized, battery internal resistance can be further reduced.

In addition, while in the present embodiment, an example in which positive and negative plates are wound so as to form the power generation element group 6 is shown, the present invention is not to be limited thereto. For instance, the power generation element group 6 may be formed by laminating positive and negative plates. As shown in FIG. 4(B), in the lamination-type power generation element group 6, the rectangular positive plates 6E and the rectangular negative plates 6D are alternately laminated through the rectangular separators 6C. At this time, they are laminated so that the uncoated sections 6A and 6B are located on the both ends of the power generation element group 6. Such lamination-type power generation element group also allows the advantageous effects similar to those of the present embodiment described above to be achieved.

In addition, while in the present embodiment, an example in which the battery can 1 and the battery lid 3 are made of aluminium is shown, the present invention is not to be limited thereto, and aluminium alloy may be used. The use of aluminium or aluminium alloy achieves weight saving compared to the use of iron material.

In addition, while in the present embodiment, an example in which the mating section 24 is formed on the edge of the opening of the battery can 1 is shown, it may be arranged that the mating section 24 is not formed and the battery can 1 is sealed by the battery lid 3. In this case, the outline of the battery lid 3 may match the outline of a member forming the opening of the battery can 1, and also the outer edge of the battery lid 3 may be placed to overlap the edge of the opening so as to be welded together.

In addition, while in the present embodiment, an example in which the insulation cases 7A and 7B have the same shape is shown, the present invention is not to be limited thereto. In the insulation case 7B, in place of forming cut-out portions on the both sides in the WH direction, a cut-out portion may be formed at least on one side including a section corresponding to the electrolyte filling inlet 20. In view of component management during the manufacture process, it is preferable to form the insulation cases 7A and 7B into the same shape. In addition, while an example in which the cut-out portions are formed to cut away the outer edge of the both sides in the WH direction of the insulation cases 7A and 7B is shown, the present invention is not to be limited thereto, and a through hole (cutout) may be formed at the end so that the outer edge remains. In other words, the concept of cut-out portion according to the present invention includes holes.

In addition, while in the present embodiment, the lithium-ion secondary battery 30 was used as an example of a secondary battery, the present invention is not to be limited thereto, and can be applied to a secondary battery in general. In addition, while in the present embodiment, an example in which lithium manganate is used as positive electrode active material and graphite is used as negative electrode active material, the present invention is not to be limited thereto, and an active material which is normally used for a lithium-ion secondary battery can be used. As a positive electrode active material, lithium transition metal complex oxide, a material that can absorb and desorb lithium ions, into which a sufficient amount of lithium ions are added in advance, may be used, or material in which lithium or some of transition metals in lithium transition metal complex oxide crystals are substituted or doped with another element may be used. In addition, crystal structure is not to be limited, and a crystal structure of any system of spinel, layered, or olivine may be included. On the other hand, negative electrode active material other than graphite may include carbonaceous material such as coke and amorphous carbon, and the particle shape may be scale-like, spherical, fibrous, aggregated, or the like, i.e., not to be limited.

In addition, the present invention is not to be limited in terms of the conductive material and the binder shown as examples in the present embodiment, and any of those normally used in a lithium-ion secondary battery can be used. Binders other than those described in the present embodiment may include polymers such as polytetrafluoroethylene, polyethylene, polystyrene, polybutadiene, butyl rubber, nitrile rubber, styrene-butadiene rubber, polysulphide rubber, nitrocellulose, cyanoethyl cellulose, various latex, acrylonitrile, vinyl fluoride, vinylidene fluoride, propylene fluoride, and chloroprene fluoride and mixtures of those.

In addition, while the present embodiment, a nonaqueous electrolytic solution in which LiPF6 is dissolved in a carbonate ester organic solvent such as ethylene carbonate is shown as an example, a nonaqueous electrolytic solution in which typical lithium salt as electrolyte is dissolved in an organic solvent may be used, and the present invention is not to be limited in particular in terms of the lithium salt and organic solvent used therein. For instance, LiClO4, LiAsF6, LiBF4, LiB(C6H5)4, CH3SO3Li, CF3SO3Li, or the like or mixtures of those may be used as an electrolyte. In addition, diethyl carbonate, propylene carbonate, 1,2-diethoxyethane, gamma butyrolactone, sulfolane, propionitrile, or the like, or a mixed solvent in which two or more of those are mixed may be used as an organic solvent.

Although the variety of embodiments and examples of variations are described above, the present invention is not to be limited only to those contents. The scope of the present invention includes other possible embodiments invented within the scope of the technical idea of the present invention.

The disclosure of the following priority application is herein incorporated by reference: Japanese Patent Application No. 2008-275137 filed on Oct. 27, 2008.

1. A secondary battery, comprising:
a battery can having a shallow, bottomed rectangular shape, in which a length of one side perpendicular to a bottom of the shallow bottomed rectangle is smaller than lengths of other two sides, and a through hole is formed in a vicinity of each of two opposite sides among four sides constituting an outer circumference of the bottom;
a battery lid that seals an opening formed on a side opposite to the bottom of the battery can;
a power generation element group, placed in a space defined by the battery can and the battery lid, that comprises positive plate and negative plate which are wound or laminated, with uncoated sections of active material mix being formed opposite with each other on the positive plate and the negative plate, and the uncoated sections of the positive plate and the negative plate being placed inside so as to face a surface in which the through holes of the battery can are formed; and
a connection member that is electrically and mechanically connected to each of the uncoated sections of the positive plate and the negative plate so as to provide electrical continuity with an outside of the battery through the through holes of the battery can.

2. A secondary battery according to claim 1, wherein:
the through hole is formed on each side region of the bottom, and the connection member which is connected to the positive plate to provide electrical continuity with the outside of the battery through the through hole extends opposite to the connection member which is connected to the negative plate to provide electrical continuity with the outside of the battery through the through hole.

3. A secondary battery according to claim 1, wherein:
the battery can includes an offset surface located in a vicinity of each of the two opposite sides among the four sides constituting the outer circumference of the bottom, with the offset surface being displaced toward the battery lid from a plane of the bottom, and the through hole is formed on the offset surface.

4. A secondary battery according to claim 3, wherein:
the battery can is provided with a plurality of the through holes formed on each of the offset surfaces, and the connection member is electrically and mechanically connected to the uncoated sections of the positive plate and the negative plate through each of the through holes.

5. A secondary battery according to claim 1, wherein:
the connection member includes a connection section electrically and mechanically connected to the uncoated sections of the positive plate and the negative plate and an extension section integrally formed with the connection section and extending outside the battery can, and the extension section is bent along an outer bottom of the battery can and along one side perpendicular to the bottom, with one end of the extension section extending toward the battery lid.

6. A secondary battery according to claim 1, wherein:
the battery can includes a safety valve which releases internal pressure when battery internal pressure rises on a side surface adjacent to any one side other than the two sides in the vicinity of which the through holes are formed.

7. A secondary battery according to claim 1, wherein:
the battery lid has an outline which matches an outline of a member forming an opening of the battery can, and is welded to the opening of the battery can.

8. A secondary battery according to claim 1, wherein:
the connection member is constituted with a connecting plate one side of which is joined to a surface toward the bottom of the battery can of each of the uncoated sections and an external terminal that includes a raised region with a flat protruding end on one side with an other side being led to outside, and the protruding end of the external terminal is joined to an other side of the connecting plate through the through hole of the battery can.

9. A secondary battery according to claim 1, wherein:
the connection member is constituted with a flat, plate-like external terminal and a cup-like connection terminal fixed to the external terminal, and a cup outer bottom surface of the connection terminal is joined to each of the uncoated sections through the through hole of the battery can.

10. A secondary battery according to claim 1, wherein:
the battery can and the battery lid are made of aluminium or aluminium alloy.

11. A secondary battery according to claim 1, further comprising:
a resin plate disposed between the power generation element group and the battery lid and between the power generation element group and the battery can.

12. A secondary battery according to claim 11, wherein:
in the resin plate disposed between the power generation element group and the battery can, cut-out portions are formed at positions corresponding to the through holes of the battery can.

13. A secondary battery according to claim 11, wherein:
a cut-out portion is formed on at least one side constituting an outer circumference of the resin plate disposed between the power generation element group and the battery lid.

14. A production method for a secondary battery according to claim 1, comprising:
a fixation step in which the connection member is fixed to each of the through holes of the battery can, with the insulating member placed therebetween;
a connection step in which the power generation element group is placed in the battery can so as to electrically and mechanically connect the connection member with the uncoated sections of the positive plate and the negative plate; and
a join step in which the battery can and the battery lid are joined.

15. A production method according to claim 14, wherein:
in the connection step, the power generation element group is placed inside so that each of the uncoated sections of the positive plate and the negative plate faces a surface on which the through holes of the battery can are formed.
